(19) United States
(12) Patent Application Publication
(10) Pub. No.: US 2022/0397859 A1
(43) Pub. Date: Dec. 15, 2022

(54) HOLOGRAPHIC LENS SYSTEM

(71) Applicant: ELECTRONICS AND TELECOMMUNICATIONS RESEARCH INSTITUTE, Daejeon (KR)

(72) Inventors: Kihong CHOI, Daejeon (KR); Keehoon HONG, Daejeon (KR); Joong-Ki PARK, Daejeon (KR)

(21) Appl. No.: 17/591,453

(22) Filed: Feb. 2, 2022

(30) Foreign Application Priority Data
Jun. 11, 2021 (KR) 10-2021-0076343
Sep. 29, 2021 (KR) 10-2021-0128941

(51) Int. Cl. G03H 1/04

(52) U.S. Cl. CPC G03H 1/0443; G03H 2001/0447; G03H 2223/20; G03H 2223/22

(57) ABSTRACT

The holographic lens system includes a geometric phase lens located on plane of an aperture, a front lens and a rear lens respectively located at the front and behind of the aperture, a polarizer located between the geometric phase lens and the front lens, and an image sensor that is located behind the rear lens and acquires an interference fringe generated by the geometric phase lens.

### CROSS-REFERENCE TO RELATED APPLICATION

This application claims priority to and the benefit of Korean Patent Application Nos. 10-2021-0076343, and 10-2021-0128941 filed in the Korean Intellectual Property Office on Jun. 11, 2021, and Sep. 29, 2021, the entire contents of which are incorporated herein by reference.

### BACKGROUND OF THE INVENTION

### (a) Field of the Invention

The present invention relates to a holographic lens system, and more particularly, to a holographic lens system that can be easily implemented using a conventional camera lens.

### (b) Description of the Related Art

Unlike general photographic technology that records only light intensity information, holography acquires and records amplitude and phase information of light propagated from an object.

Until now, there has been no sensor that can directly record the amplitude and phase information of visible light, so the relevant information is obtained indirectly through light interference. Interference is a phenomenon that occurs when two light waves, called object light and reference light, interact, but it is difficult to obtain an interference fringe unless a laser, which is artificially aligned in amplitude and phase, is not used. Therefore, until recently, lasers were mainly used for holographic techniques.

Self-interference holography acquires an interference fringe in a self-referencing method that divides incident waves emitted and reflected from an object according to a spatial or polarization state. The divided light waves are modulated into wavefronts with different curvatures under the influence of an interferometer or a polarization modulator, and propagated to form an interference fringe on the image sensor. In this case, since the interference occurs between twin light waves caused by light originating from the same space-time, it is free from the condition of the light source compared to the interference condition using a laser. Therefore, it is possible to photograph under fluorescent, light bulb, LED (light-emitting diode), or natural light conditions.

Although the concept of this self-interference holography technology has been established, a complex optical system must be applied to separate incident light to form an interference fringe, and it requires a lot of design requirements to renew an optimal lens design such as aberration correction from the point of view of a holographic lens, so it is not easy to implement into an actual product. In addition, since the existing camera lens acquires only two-dimensional intensity information, it is impossible to reproduce three-dimensional spatial light information, so it is difficult to obtain a hologram.

### SUMMARY OF THE INVENTION

The present invention has been made in an effort to provide a holographic lens system capable of easily acquiring a holographic image by using a conventional camera lens. In an example embodiment, a holographic lens system is provided. The holographic lens system includes: a geometric phase lens located on plane of an aperture; a front lens and a rear lens respectively located at the front and behind of the aperture; a polarizer located between the geometric phase lens and the front lens; and an image sensor that is located behind the rear lens and acquires an interference fringe generated by the geometric phase lens.

When the geometric phase lens has a phase delay characteristic of a half-wave plate, the polarizer may be a linear polarizer.

When the geometric phase lens has a phase delay characteristic of a quarter-wave plate, the polarizer may be a circular polarizer.

The holographic lens system may further include a spacer that adjusts the distance between the image sensor and the rear lens.

When the geometric phase lens has a phase delay characteristic of a quarter-wave plate, the polarizer may include a linear polarizer and a quarter-wave plate rotated by 45 degrees.

The holographic lens system may further include a linear polarizer that is located between the rear lens and the image sensor and matches the polarization state.

The linear polarizer may be rotated 4 times at intervals of 45 degrees.

The image sensor may be a polarization image sensor in which linear polarizers are formed in directions of 0 degrees, 45 degrees, 90 degrees, and 135 degrees in front of each pixel for every four pixels.

According to another embodiment, a holographic lens system is provided. The holographic lens system includes: a camera lens system including an aperture, a front lens, and a rear lens formed in front and behind the aperture; a geometric phase lens located on a plane of the aperture; a polarizer located between the geometric phase lens and the front lens; an image sensor that is located behind the rear lens and acquires an interference fringe generated by the geometric phase lens; and a linear polarizer located between the rear lens and an image sensor to match the polarization state.

The holographic lens system includes: a camera lens system including a diaphragm surface and a front lens and a rear lens formed before and after the diaphragm surface; a geometric phase lens located on the diaphragm surface; a polarizing plate located between the geometric phase lens and the front lens; a linear polarizer positioned between the rear lens and the image sensor to match the polarization state; and an image sensor positioned behind the rear lens to acquire an interference fringe generated by the geometric phase lens.

When the geometric phase lens has a phase delay characteristic of a half-wave plate, the polarizer may be a linear polarizer

When the geometric phase lens has a phase delay characteristic of a quarter-wave plate, the polarizer may be a circular polarizer.

The linear polarizer may be rotated 4 times at intervals of 45 degrees. The image sensor may be a polarization image sensor in which linear polarizers are formed in directions of 0 degrees, 45 degrees, 90 degrees, and 135 degrees in front of each pixel for every four pixels.

### BRIEF DESCRIPTION OF THE DRAWINGS

FIG. 1 is a diagram illustrating optical characteristics of a geometric phase lens according to an embodiment.

FIG. 2 is a diagram illustrating the output of a geometric phase lens having a half (½) wave plate characteristic.

FIG. 3 is a diagram illustrating an output of a geometric phase lens having a quarter (¼) wave plate characteristic.

FIG. 4 is a diagram illustrating a basic configuration of a self-interference holographic lens system according to an embodiment.

FIG. 5 is a diagram illustrating the structure of a conventional camera lens system according to an embodiment.

FIG. 6 is a conceptual diagram schematically illustrating a holographic lens system according to an embodiment.

FIG. 7 is a diagram illustrating a polarization image sensor.

FIGS. 8 and 9 are diagrams each illustrating a holographic lens system according to an embodiment.

### DETAILED DESCRIPTION OF THE EMBODIMENTS

Hereinafter, embodiments of the present invention will be described in detail with reference to the attached drawings so that a person of ordinary skill in the art may easily implement the present invention. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, when a part is referred to “include” a certain element, it means that it may further include other elements rather than exclude other elements, unless specifically indicated otherwise.

Now, a holographic lens system according to an embodiment of the present invention will be described in detail with reference to the drawings.

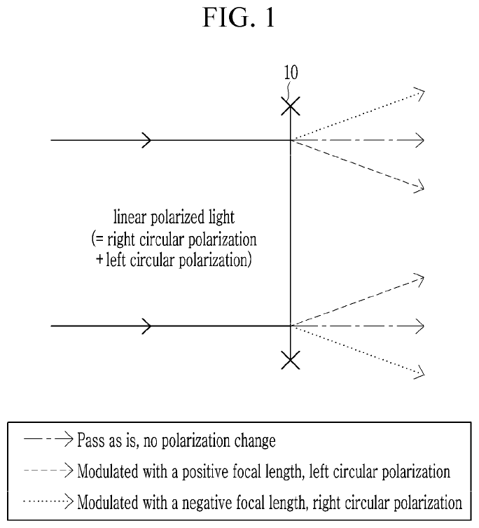

FIG. 1 is a diagram illustrating optical characteristics of a geometric phase lens according to an embodiment.

By spatially controlling the optical axis of an anisotropic molecule, the phase of progressing light can be modulated. In this case, the modulated phase is called a geometric phase or Pancharatnam-Berry (PB) phase, not a phase caused by a difference in optical paths.

In the case of making a thin-film lens through a specific arrangement of molecules, the rotation angle ϕ of each material on a two-dimensional plane composed of the x-axis and the y-axis is determined by Equation 1. In this case, f is the focal length of the lens to be manufactured. Such a thin-film lens is called a meta-lens (metasurface lens) or a geometric phase lens.

$$Φ = \frac{2 π}{λ} ( \sqrt{{x}^{2} + {y}^{2} + {f}^{2}} - f ) \qquad ( Equation 1 )$$

As shown in FIG. 1, the geometric phase lens 10 outputs light of various polarization states according to the polarization state of the incident light. When linear polarized light is input, a component without polarization modulation as it passes through, a modulated left circular polarization component with a positive focal length, and a modulated right circular polarization component with a negative focal length are output. At this time, the component without polarization modulation can be controlled by the lens efficiency.

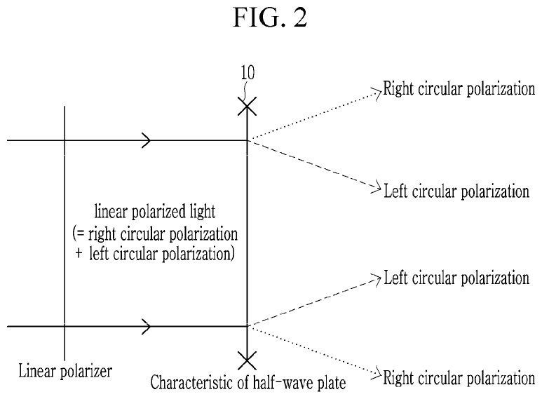

FIG. 2 is a diagram illustrating the output of a geometric phase lens having a half (½) wave plate characteristic.

Referring to FIG. 2, when the phase delay characteristic of the geometric phase lens 10 is a half-wave plate, a component passing as it is when linearly polarized light is input becomes 0, and a left circularly polarized component and a right circularly polarized component are output.

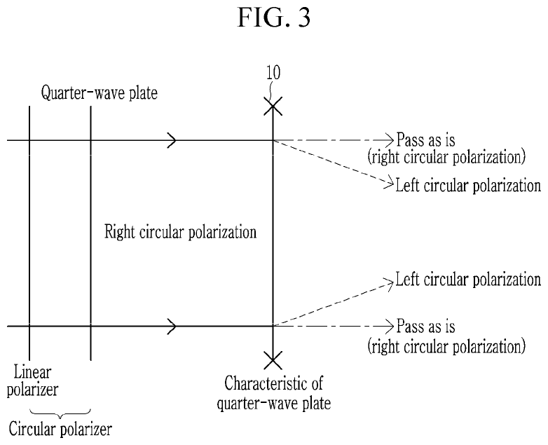

FIG. 3 is a diagram illustrating an output of a geometric phase lens having a quarter (¼) wave plate characteristic.

Referring to FIG. 3, when the phase delay characteristic of the geometric phase lens 10 is a quarter-wave plate, the component passing as it is, when circularly polarized light is input, is half, and the remaining components are the left circularly polarized component and the left circularly polarized light component.

Two polarization modulation methods for self-interference can be disclosed as shown in FIGS. 2 and 3 by using the output characteristics of the geometric phase lens 10.

In the case of FIG. 2, since there is no light passing as it is, converging and diverging lights may cause self-interference.

In the case of FIG. 3, in the linear polarizer and the quarter-wave plate rotated by 45 degrees constituting the circularly polarizer, left-circularly polarized light, or right-circularly polarized light is incident depending on the rotation state of the quarter-wave plate by ±45 degrees. Half of the incident light passes as it is, and the other half of the incident light is modulated to the opposite circular polarization state, and converging or diverging lights may cause self-interference.

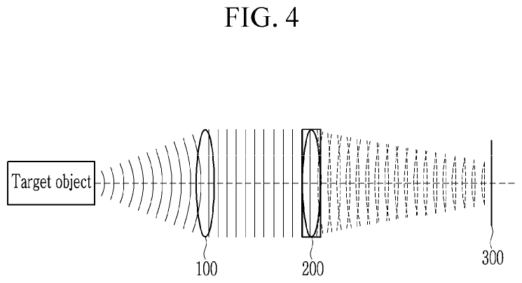

FIG. 4 is a diagram illustrating a basic configuration of a self-interference holographic lens system according to an embodiment.

Referring to FIG. 4, the self-interference holographic system acquires an interference fringe in a self-interference method from incident light propagating from a target object.

Such the self-interference holographic system may basically include an incident lens 100, a geometric phase lens 200, and an image sensor 300.

Incident light propagating from the target object passes through the incident lens 100 and is incident on the geometric phase lens. The incident lens 100 performs an objective lens function such as in a general camera or microscope.

The geometric phase lens 200 modulates incident light into left circularly polarized light and right circularly polarized light.

An interference fringe is generated by mutual interference of the modulated left circularly polarized light and right circularly polarized light, and the interference fringe is generated on the image sensor 300 and acquired by the image sensor 300.

A holographic image may be obtained through an interference fringe obtained by the image sensor 300.

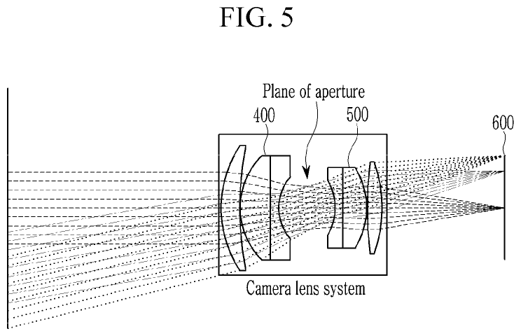

FIG. 5 is a diagram illustrating the structure of a conventional camera lens system according to an embodiment.

Referring to FIG. 5, in a conventional camera lens system, lenses 400 and 500 are disposed with opposite curvatures in front and behind with respect to the aperture plane. The lens 400 in front of the aperture plane is called a front lens, and the rear lens 500 behind the aperture plane is called a rear lens. Although a double Gauss lens is illustrated as the lenses 400 and 500 in FIG. 5, the lenses 400 and 500 are not limited thereto, and other lenses may be used.

The aperture plane is designed based on the point where all the light entering the camera passes, so the amount of light is adjusted according to the width of the aperture, and the aberration change that occurs at this time can be minimized.

Light and the target object are input to the camera through the camera lens system, and the shape of the target object is formed by the image sensor 600.

The holographic lens system according to an embodiment is implemented using a conventional camera lens structure.

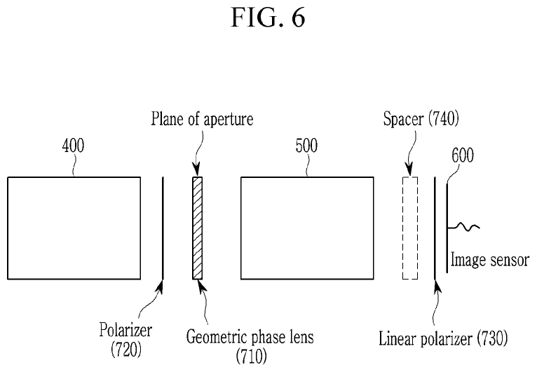

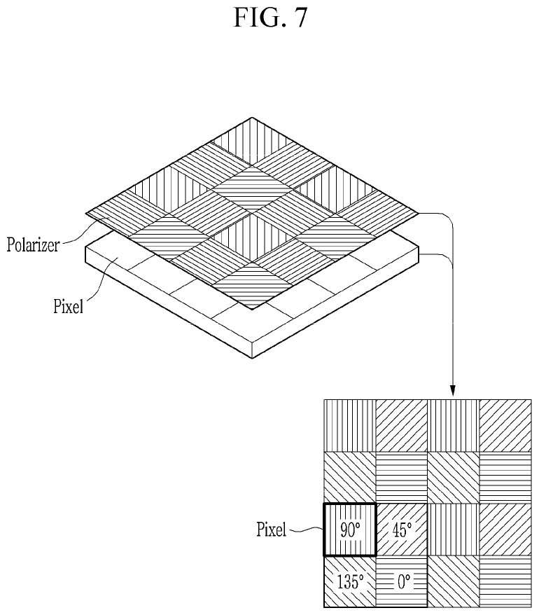

FIG. 6 is a conceptual diagram schematically illustrating a holographic lens system according to an embodiment, and FIG. 7 is a diagram illustrating a polarization image sensor.

Referring to FIG. 6, the holographic lens system may further include a polarizer 720 and a linear polarizer 730 along with the general configuration shown in FIG. 4.

A geometric phase lens 710 is disposed on the aperture plane of the camera lens system. The geometric phase lens 710 can be attached to or detached from the aperture plane. As the geometric phase lens 710 is detachable, it is possible to switch between a general camera and a holographic camera.

The incident lens 100 shown in FIG. 4 may be used as the front lens 400 of the camera lens system.

The polarizer 720 is positioned between the front lens 400 of the camera lens system and the geometric phase lens 710, and the linear polarizer 730 is positioned between the rear lens 500 and the image sensor 600 of the camera lens system.

The geometric phase lens 710 is a thin film diffractive lens made of liquid crystal or another anisotropic material, and may have a phase delay characteristic of a ½ or ¼ wave plate.

The polarizer 720 may be a linear polarizer or a circular polarizer depending on the degree of phase delay of the geometric phase lens 710. The circular polarizer may be composed of a combination of a linear polarizer and a quarter wave plate.

By separating the image points through the geometric phase lens 710, in the case of the geometric phase lens 710 having a half-wave plate characteristic, the image points formed on the focal plane of the camera lens disappear and new ones are formed in front and behind of the focal plane of the camera lens. Accordingly, if the image sensor 600 is disposed at an appropriate position, a holographic image may be acquired by self-interference.

The linear polarizer 730 is used to make the same polarization component to cause interference between two lights.

The image sensor 600 acquires a series of interference fringes phase-shifted by periodic rotation of the linear polarizer 730.

In the holographic technology, information of a light source and twin-image information of a target object are recorded together in the image sensor 600 for acquiring a holographic image through an interference fringe, and the information of a light source and twin-image information act as noise. Therefore, such light source and pair image information should be removed from the holographic image.

In an embodiment, by rotating the linear polarizer 730 four times at 45 degree intervals, information on a light source and pair image information of the target object can be removed.

Alternatively, as shown in FIG. 7, a polarization image sensor may be used. The polarization image sensor has a structure in which linear polarizers are attached in the directions of 0 degrees, 45 degrees, 90 degrees, and 135 degrees in front of each pixel for every four pixels of the image sensor 600. For example, in 4 pixels of 2×2, linear polarizers in 90 degree and 45 degree directions may be attached in front of pixels on odd lines, and linear polarizers in 135 degrees and 0 degrees directions may be attached in front of pixels on even lines.

Also, the holographic lens system may further include a spacer 740. The spacer 740 adjusts the distance between the image sensor 600 and the rear lens 500 if necessary.

The holographic lens system may have a different structure according to the phase delay characteristics of the geometric phase lens 710.

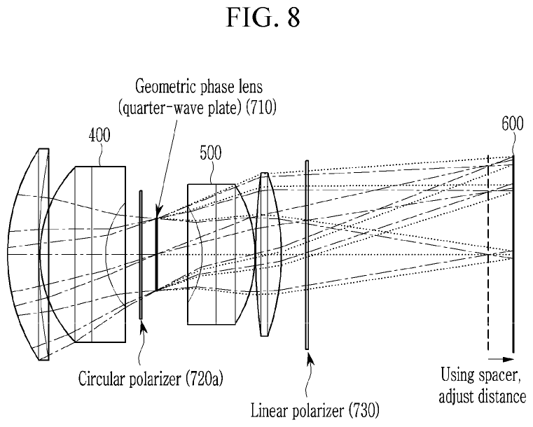

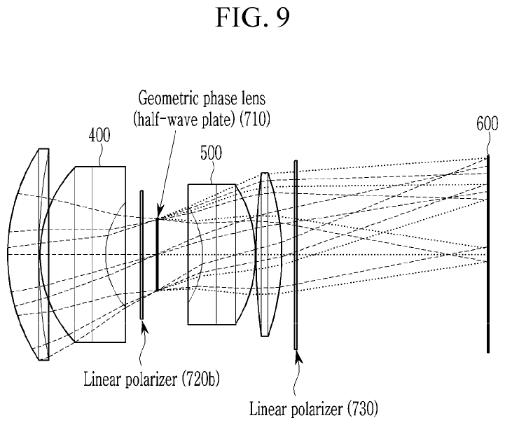

FIGS. 8 and 9 are diagrams each illustrating a holographic lens system according to an embodiment.

As shown in FIG. 8, when the geometric phase lens 710 has a phase delay characteristic of a quarter-wave plate, a circular polarizer 720a between the front lens 400 and the geometric phase lens 710 is used as the polarizer 730.

Then, in addition to the image points formed on the image sensor plane by the camera lens system, one more image point may be formed on the back plane of the image sensor 600. Accordingly, if the camera body and the holographic lens system are combined while forming an appropriate distance using the spacer 740, the image sensor plane is located between the two image points and an interference fringe can be obtained.

On the other hand, as shown in FIG. 9, when the geometric phase lens 710 has a phase delay characteristic of a half-wave plate, a linear polarizer 720b is used between the front lens 400 and the geometric phase lens 710 as the polarizer 730.

Then, the image point formed on the image sensor plane by the camera lens system disappears and the image points are formed in front and behind of the image sensor 600. In this case, an interference fringe can be obtained by combining the holographic lens system with the camera body without the spacer 740.

As described above, in the embodiment, by using the conventional camera lens system, it is possible to more easily implement the holographic lens system.

According to an embodiment of the present invention, by implementing a holographic lens system using the conventional camera lens system, it can be easily converted into a lens that can acquire holograms by utilizing the optimal design of the conventional camera lens. Furthermore, by attaching and detaching a geometric phase lens, it is possible to easily switch between a general camera and a holographic camera.

The components described in the example embodiments may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the example embodiments may be implemented by software, and the software may be recorded on a recording medium. The components, functions, and processes described in the example embodiments may be implemented by a combination of hardware and software. The method according to embodiments may be embodied as a program that is executable by a computer, and may be implemented as various recording media such as a magnetic storage medium, an optical reading medium, and a digital storage medium. Various techniques described herein may be implemented through digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing, or to control an operation of a data processing apparatus, e.g., by a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network. Processors suitable for execution of a computer program include, by way of example, both general and special purpose microprocessors, and any one or more processors of any kind of digital computer. Generally, a processor will receive instructions and data from a read-only memory or a random access memory or both.

Elements of a computer may include at least one processor to execute instructions and one or more memory devices to store instructions and data. Generally, a computer will also include or be coupled to receive data from, transfer data to, or perform both on one or more mass storage devices to store data, e.g., magnetic or magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., and magneto-optical media such as a floptical disk and a read only memory (ROM), a random access memory (RAM), a flash memory, an erasable programmable ROM (EPROM), and an electrically erasable programmable ROM (EEPROM), and any other known computer readable media. A processor and a memory may be supplemented by, or integrated into, a special purpose logic circuit.

The processor may run an operating system (08) and one or more software applications that run on the OS. The processor device also may access, store, manipulate, process, and create data in response to execution of the software. For the purpose of simplicity, the description of a processor device is used as singular; however, one skilled in the art will appreciate that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media. The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination. Similarly, even though operations are described in a specific order in the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products. It should be understood that the embodiments disclosed herein are merely illustrative and are not intended to limit the scope of the invention. It will be apparent to one of ordinary skill in the art that various modifications of the embodiments may be made without departing from the spirit and scope of the claims and their equivalents.

What is claimed is:

1. A holographic lens system comprising:
a geometric phase lens located on a plane of an aperture;
a front lens and a rear lens respectively located at the front and back of the aperture;
a polarizer located between the geometric phase lens and the front lens; and
an image sensor that is located behind the rear lens and acquires an interference fringe generated by the geometric phase lens.

2. The holographic lens system of claim 1, wherein when the geometric phase lens has a phase delay characteristic of a half-wave plate, the polarizer is a linear polarizer.

3. The holographic lens system of claim 1, wherein when the geometric phase lens has a phase delay characteristic of a quarter-wave plate, the polarizer is a circular polarizer.

4. The holographic lens system of claim 3, further comprising a spacer that adjusts the distance between the image sensor and the rear lens.

5. The holographic lens system of claim 1, wherein when the geometric phase lens has a phase delay characteristic of a quarter-wave plate, the polarizer includes a linear polarizer and a quarter-wave plate rotated by 45 degrees.

6. The holographic lens system of claim 1, further comprising a linear polarizer that is located between the rear lens and the image sensor and matches the polarization state.

7. The holographic lens system of claim 6, wherein the linear polarizer that is rotated 4 times at intervals of 45 degrees.

8. The holographic lens system of claim 1, wherein the image sensor that is a polarization image sensor in which linear polarizers are formed in directions of 0 degrees, 45 degrees, 90 degrees, and 135 degrees in front of each pixel for every four pixels.

9. A holographic lens system comprising:
a camera lens system including an aperture, a front lens, and a rear lens formed in front and behind the aperture;
a geometric phase lens located on a plane of the aperture;
a polarizer located between the geometric phase lens and the front lens;
an image sensor that is located behind the rear lens and acquires an interference fringe generated by the geometric phase lens; and
a linear polarizer located between the rear lens and an image sensor to match the polarization state.

10. The holographic lens system of claim 9, wherein when the geometric phase lens has a phase delay characteristic of a half-wave plate, the polarizer is a linear polarizer.

11. The holographic lens system of claim 9, wherein when the geometric phase lens has a phase delay characteristic of a quarter-wave plate, the polarizer is a circular polarizer.

12. The holographic lens system of claim 9, wherein the linear polarizer that is rotated 4 times at intervals of 45 degrees.

13. The holographic lens system of claim 9, wherein the image sensor is a polarization image sensor in which linear polarizers are formed in directions of 0 degrees, 45 degrees, 90 degrees, and 135 degrees in front of each pixel for every four pixels.
